(19) United States
(12) Patent Application Publication
(10) Pub. No.: US 2013/0339100 A1
(43) Pub. Date: Dec. 19, 2013

(54) DECISION SUPPORT TOOL FOR OPERATION OF A FACILITY

(71) Applicants: Philip H. WARRICK, Oakton, VA (US); Gary R. KOCIS, Vienna, VA (US); Jayanth BALASUBRAMANIAN, Fairfax, VA (US); David C. SMITH, Southampton (GB)

(72) Inventors: Philip H. WARRICK, Oakton, VA (US); Gary R. KOCIS, Vienna, VA (US); Jayanth BALASUBRAMANIAN, Fairfax, VA (US); David C. SMITH, Southampton (GB)

(73) Assignee: EXXONMOBIL RESEARCH AND ENGINEERING COMPANY, Annandale, NJ (US)

(21) Appl. No.: 13/913,671

(22) Filed: Jun. 10, 2013

Related U.S. Application Data
(60) Provisional application No. 61/660,373, filed on Jun. 15, 2012.

(51) Int. Cl. G06Q 10/06

(52) U.S. Cl. CPC G06Q 10/0637
USPC 705/7.36

(57) ABSTRACT

A decision support tool to assist decision-making in the operation of a facility. The decision support tool allows the user to compare the performance of different strategies for the operation of the facility so that the organization can make better-informed judgments about which approach to use. The decision support tool can also allow for the modification of strategies to improve their performance.

### TECHNICAL FIELD

The presently disclosed subject matter relates to decision support tools for the operation of a facility, such as the planning and scheduling operations of the facility. In particular, the presently disclosed subject matter relates to a planning and scheduling decision support tool that utilizes a strategy based approach for planning and scheduling operations in and around a facility (e.g., a petrochemical or refining facility).

### BACKGROUND

Conventional decision support tools for planning and scheduling problems in the oil and gas industry have used simulation and/or optimization models as the principal solution technology. These planning and scheduling tools are model-based and numerical in nature. The output from these tools is also numerical. For example, the output from an optimization model is a set of solution values for the model variables. The outputs imply the decisions or actions to be taken. However, the use of an optimization-based solution alone has certain limitations.

The set of solution values for the model variables by itself is often insufficient for the decision-maker. The decision-maker also needs to understand the intent, design, or motivation behind a particular numerical output. The optimization-based approach does not identify the strategy that yielded the optimal solution. In most cases, the strategy for optimization-based solution must be inferred. This lack of understanding limits the effective use of these numerically-based planning and scheduling tools. Furthermore, the underlying strategy used in the optimization may not be suitable or best for the particular business at the time. While the profitability of the optimized results can be determined, the profitability of the inferred strategy remains unclear. As such, the most profitable strategy or the strategy most suited for the particular situation may not have been found. Without a full understanding of the results and their implications, the results may not be communicated easily to higher levels of management or operations staff Furthermore, users may be hesitant to execute decisions that are not intuitively understood. In particular, facility operators may be more accustomed to dealing with decision-making that follows a step-by-step process based on business logic. In addition, relying on the optimizer results may not align with a consistent decision-making process. Finally, it is difficult to properly assess the robustness of the optimizer results in light of the uncertainty of the inputs and the model itself.

The simulation based approach has similar limitations. The simulation based approach is not strategy based and frequently relies upon trial and error for purposes of identifying suitable planning and scheduling decisions. The decision makers may run hundreds of cases in order to develop a program that in the end may not meet all of the desired business needs. The simulation approach is rule based and like the optimization approach does not produce results that are intuitively understood.

Neither the simulation approach nor the optimization approach attempt to minimize the uncertainty associated with unknown variables or parameters (e.g., fluctuations in price, availability of supply or timing of delivery). Furthermore, given the lack of understanding associated with the underlying strategy utilized for performing either the simulation or the optimization, it is difficult to measure the success of the results against a performance metric (e.g., net profit, product slate, timing, etc.).

Also, plans and schedules are forward looking, but conditions that will occur in the future may not be known with certainty. Thus, when using a decision support tool with uncertain future conditions, the user may need to repetitively enter multiple different case scenarios to cover the range of possible conditions that may occur. This magnifies the challenge of determining the intent or motivation behind a collection of case scenarios and their corresponding results. Thus, there is a need for a tool that is capable of assessing different approaches to solving the planning/scheduling problem and provides output that overcomes the deficiencies of the prior art.

### SUMMARY

The presently disclosed subject matter relates to a strategy based planning and scheduling tool that provides decision-makers with the ability to compare the performance of different strategies for the operation of the facility so that the organization can make better-informed judgments about which approach to use. The presently disclosed subject matter provides a method of planning, scheduling and operating a facility. The method comprises: (a) using a computer system that stores a strategy-based module comprising multiple different strategies, each comprising a procedure for determining the operation of the facility; wherein the strategies use multiple input parameters, wherein at least one of the input parameters is an uncertain parameter having multiple possible values; (b) generating a set of input cases, each input case containing a different set of values for the parameters, and each input case being associated with a weighting for that set of values for the parameters; (c) applying each strategy to the set of input cases using the strategy-based module and calculating a performance metric for each strategy for each input case; (d) analyzing the weighted distribution of the performance metric over the set of input cases for each strategy; (e) selecting or modifying a strategy based on the analysis of the weighted distributions; and (f) operating the facility according to the results of the selected or modified strategy.

The step of generating of the set of input cases may include receiving multiple input values for each uncertain parameter and a weighting factor for each input value relating to the weighting of that input value. The weighting factors depend on the relative impact desired for each alternative value. For example, this may correspond to the likelihood or importance. The weighting of each input case is calculated using the weighting factors of the input values of the uncertain parameters. The weighting factor for each input value is a normalized relative weighting of that input value within the sample of input values being used, and wherein the weighting factors of the input values in each input case are used (for example, the weighting factors can be multiplied) to calculate the weighting of that input case.

The step of generating the set of input cases may also include receiving historical data for one or more of the uncertain parameters; fitting a model to the historical data; selecting multiple values from the fitted model; and assigning a weighting factor for each of the selected values based on the weighting of that input value occurring.

In accordance with aspects of the presently disclosed subject matter, operating the facility includes one or more of physically transferring a material to or from a vessel, physically transferring a material to or from a storage tank, physically transferring a material to or from processing equipment, or transforming a feed or raw material into a different material.

The presently disclosed subject matter provides a computer system for planning, scheduling and determining the operation of a facility, the computer system being programmed to perform steps that comprise: (a) storing a strategy-based module comprising multiple different strategies, each comprising a procedure for determining the operation of the facility; wherein the strategies use multiple input parameters, wherein at least one of the input parameters is an uncertain parameter having multiple possible values; (b) generating a set of input cases, each input case containing a different set of values for the parameters, and each input case being associated with a weighting for that set of values for the parameters; (c) applying each strategy to the set of input cases using the strategy-based module and calculating a performance metric for each strategy for each input case; and (d) analyzing the weighting distribution of the performance metric over the set of input cases for each strategy. In another embodiment, the present invention provides a non-transitory machine-readable storage medium comprising instructions which, when executed by a processor, cause the processor to perform these steps.

In another embodiment, the present invention provides a method of operating a facility, which comprises: (a) using a computer system that stores a strategy-based module comprising multiple different strategies, each comprising a procedure for determining the operation of the facility; wherein the strategies use multiple input parameters; (b) generating an input case that defines a set of values for the input parameters; (c) applying each strategy to the input case using the strategy-based module and calculating a performance metric for each strategy; (d) comparing the performance metric results for the different strategies; (e) selecting or modifying a strategy based on the comparison; and (f) operating the facility according to the results of the selected or modified strategy.

### BRIEF DESCRIPTION OF THE DRAWINGS

FIG. 1 shows an example of a refinery to which the tool of the present invention can be applied.

FIG. 2 shows an example of actions that can be applied for working with strategies.

FIG. 3 shows an example of actions that can be applied for working with strategy libraries.

FIG. 4 shows a flowchart illustrating an example of a strategy process that can be used in the present invention.

FIG. 5 shows an example of actions that can be applied for entering inputs for uncertain parameters.

FIG. 6 shows an example of actions that can be applied for working with case sets.

FIG. 7 shows an example of actions that can be applied for applying strategies to cases.

FIG. 8 shows a plot of cumulative distribution curves for three different strategies.

FIG. 9 shows a plot illustrating an example of a risk profile for the total net margin performance metric.

FIG. 10 shows a plot illustrating the probability distribution profile for each strategy.

### DETAILED DESCRIPTION

The presently disclosed subject matter provides a tool for the operation of a facility(s). The tool is preferably a decision support tool, but is not intended to be so limited; rather, it is contemplated that other tools or means that enable planning and scheduling utilizing a strategy are within the scope of the presently disclosed subject matter. The presently disclosed subject matter will be described in connection with a petrochemical facility for purpose of illustration. It is intended that the presently disclosed subject matter may be used in any facility where planning and scheduling operations are a normal part of operating the facility. The operation of a petrochemical facility may involve various decisions, including the planning of activities, scheduling of activities, process operations, blending operations, transportation of materials (e.g. feeds, intermediates, or products) to and/or from the facility (e.g. via maritime shipping, rail, truck, pipeline, etc.), cargo assignments, vessel assignments, selection of raw or feed materials, and the timing of these activities. Examples of petrochemical facilities include, but is not limited to, refineries, storage tank farms, chemical plants, lube oil blending plants, pipelines, distribution facilities, LNG facilities, basestock production facilities, and blending facilities. The presently disclosed subject matter may also be used in connection with facilities that produce and transport crude oil. It is also contemplated that the presently disclosed subject matter may be used in other operations and facilities that are not associated with petroleum and petrochemical processing, but where planning and scheduling issues are present.

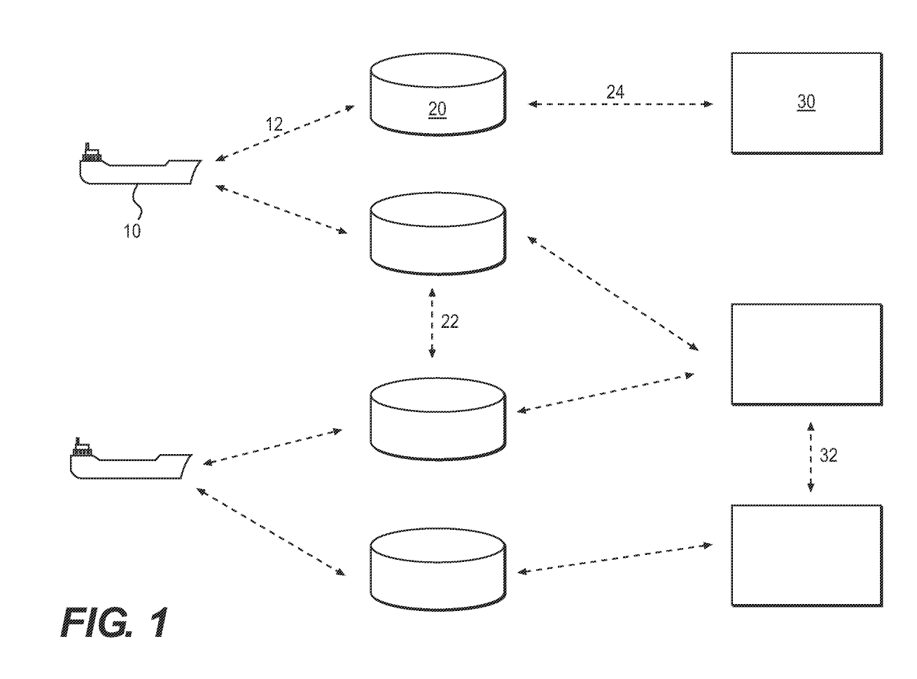

FIG. 1 shows an example of a refinery that can be operated utilizing the presently disclosed subject matter. The refinery includes storage tanks 20 and processing equipment 30 (e.g. crude distillation units, catalytic cracking units, hydrocracking units, blenders, reactors, separation units, mixers, etc.). Operations in the refinery include the transfer 12 (discharging and/or loading) of materials between the ships 10 and storage tanks 20. There may also be transfers 22 of material between tanks 20. There may also be transfer 24 of materials between storage tanks 20 and processing equipment 30. There may also be transfer 32 of materials between processing equipment 30. Processing equipment 30 may transform a feed material or raw material into a different material (e.g. by distillation, mixing, separation, or chemical reaction). The operation of the refinery can include numerous other activities, such as selection of raw materials, etc. The tool in accordance with the presently disclosed subject matter may be utilized to plan and schedule for the operation of the facility.

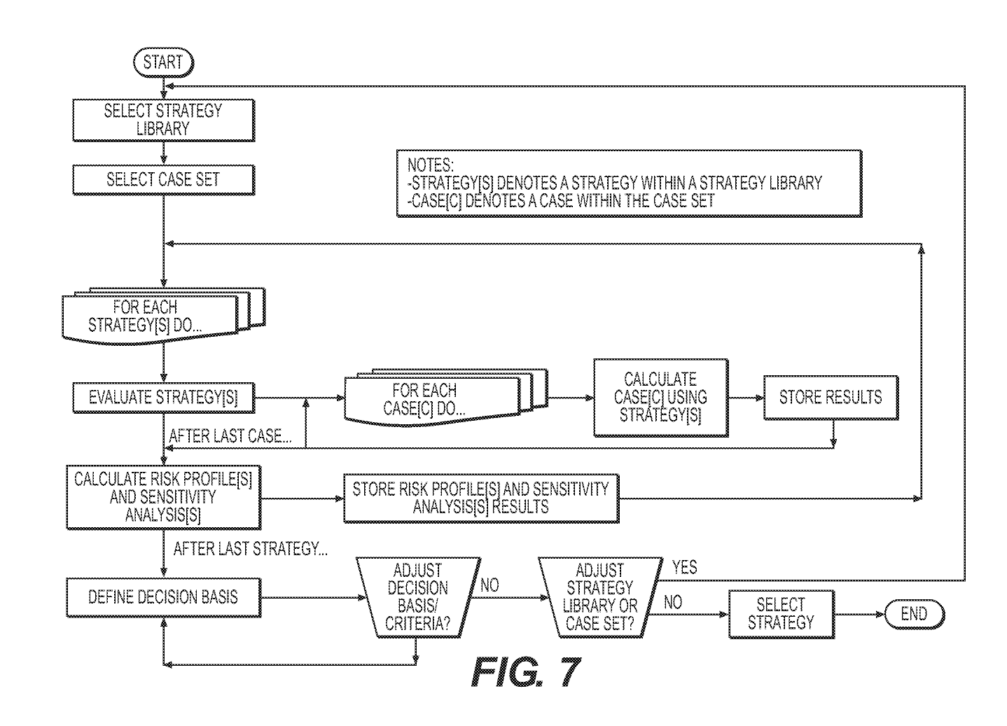

The presently disclosed subject matter enables the planning and scheduling of a facility based upon the use of a selected strategy or strategies. The tool preferably includes a computer system. The computer system includes a strategy based decision making module for planning and scheduling operations (which include but is not limited to the supply of raw materials to the facility, the product slate produced by the facility, the capacity and operating conditions of the units within the facility). The module preferably contains at least one library and each library contains at least one strategy. It is contemplated that the strategy based module contains at least one library. FIG. 7 illustrates steps that comprise the decision making process. The user may first identify a relevant library of strategies. For example, a library of strategies utilized for a particular location, geographic region, circumstance, or event.

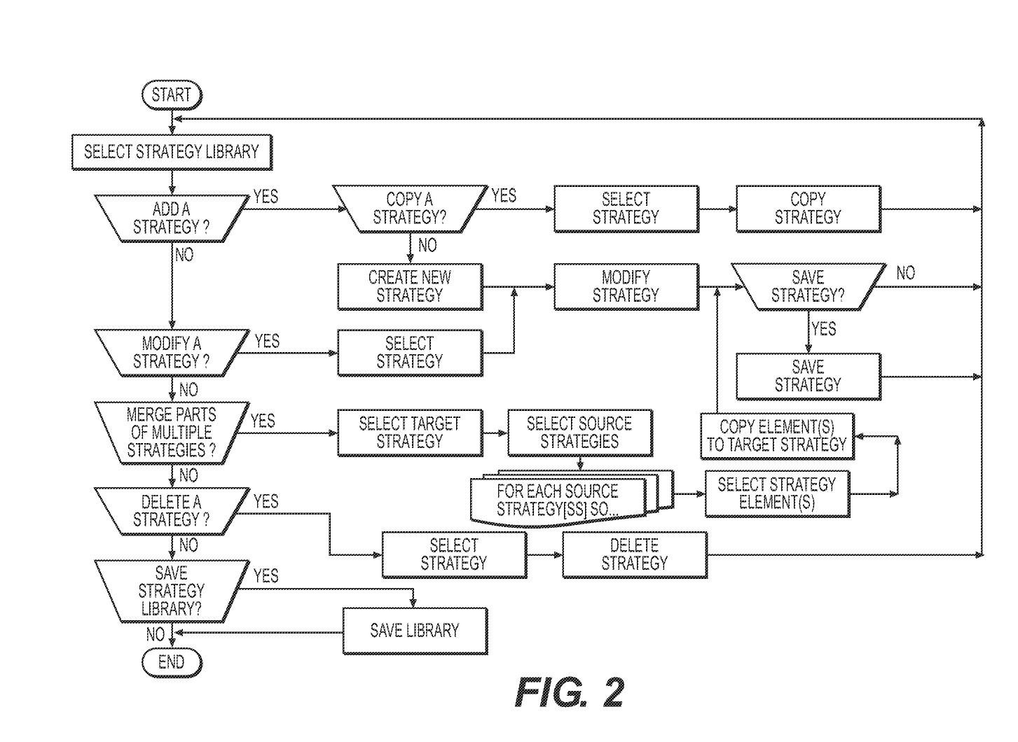

The methodology disclosed in FIG. 2 can be used to modify, manipulate, create, delete, and perform other related operations on strategies. Each strategy is unique and contains certain business drivers or known external factors. Each can be designed to address uncertain parameters. The results obtained from the use of strategy may represent the best result for scheduling and operating the facility taking into account the specific objectives of the strategy (e.g., output of a specific product, supply of raw materials from a particular region, shifting resources such that a particular unit within the facility can be taken offline without impacting the operation of the entire facility.)

It is contemplated that the strategies can be adapted or refined to create new strategies taking into account additional known factors or business drivers. In addition, the strategies may be modified or adapted to minimize the impact of uncertain parameters on the planning and scheduling decisions such that these decisions can be made with greater certainty. The strategies may be modified or adapted to improve performance with respect to a desired performance metric. The strategies may be location specific (e.g., country specific, geographic region specific or facility specific). The strategy is focused to select or accomplish the desired business needs, which may vary from day to day. For example, the desired product slate produced by the facility may vary based upon, inter alia, market conditions, time of year, geopolitical conditions, and other external factors such as weather. The optimal planning and scheduling for and the operation of the facility may vary based upon each of these factors. The use of the strategy based module in accordance with the presently disclosed subject matter permits the decision makers to properly and optimally plan for changing conditions such that these conditions are factored into the planning and scheduling process.

As mentioned above, the strategy can be developed to address specific conditions, business drivers and other external influences. For example, specific strategies can be developed and utilized within the module that are based upon certain factors such as the supply of raw materials from a specific region of the world, the disruption of such supply, the cost of shipping, etc. Furthermore, specific strategies can be utilized to address certain unexpected conditions (e.g., weather, or the shutdown or failure of a facility unit). The business drivers and goals in advance of, during and after a weather related event (e.g. a hurricane) are very different from normal business drivers. The uncertain parameters associated with these conditions may impact the generated results. The desire to have the facility ready in advance of the weather event will vary the previously planned and scheduled operations. The use of the weather based strategy will permit the users to identify a plan most suited and most effective for addressing the business drivers for operating in advance of the weather event (e.g., unit shutdown, redirecting or delaying the supply of raw materials, etc).

In petrochemical and refining operations, unexpected weather conditions are not the only weather conditions that impact the operation of the facility and the planning and scheduling associated with the same. For example, the product slate produced in colder weather may differ from the product slate produced in the same facility during warmer seasons. Having specific strategies which address such needs allows the planners and operators to more effectively adapt to the changing needs, minimize variances or the impact associated with uncertain parameters and provide a strategic basis for why the plan for operating the facility has been altered or modified. A specific strategy may be employed during a cold winter and a different strategy with different drivers employed during a mild winter.

The use of the strategy based module and the library of strategies contained therein in accordance with the presently disclosed subject matter allows the user to utilize a strategy that is most suited for a particular situation. The strategies focus on forward planning and business needs, as such, the use of the such strategies introduces a certain level of stability in the decision making process that is not present in the non-strategy approaches. In response to changes in uncertain or known parameters, the simulation based approach and the optimization approach create a new solution set that completely revamps a previously developed schedule. By contrast, the use of the strategy based approach will permit the decision maker to identify what impact the changes in the parameters have on the schedule and what if any revisions are needed. For example, the change may have minimal impact on the results when compared to the performance metric. As such, it may be preferable to continue to use the strategy which had been chosen previously. The business drivers contained in the strategy can then be used to explain and justify the plan or result obtained based upon the strategy. These results may not be the best when compared to the results obtained, for example, from a scheduling optimizer, but the results will likely be the best to achieve the desired business objectives of the selected strategy.

The presently disclosed subject matter allows the comparison of different approaches to decision making for operating a manufacturing facility on the basis of their relative performance and robustness. In one embodiment, the present disclosed subject matter is a computer-implemented method for determining the operation of a facility. The method uses a computer system that is programmed to use a strategy-based module. The user or a decision maker may select a set of strategies (i.e. a strategy library) for consideration. It is also contemplated that the user could input several parameters or desired business objectives. The strategies can be evaluated using one or more input cases, and the results can be compared. The user may select one (or multiple) preferred strategy, or the tool may be used to determine the preferred strategy. The selected strategy provides the planning and scheduling decision making basis for operating the facility.

It is also contemplated that the user can combine, delete and/or modify strategies to create new strategies with specific business drivers. It is contemplated that each of the strategies associated with the various libraries will receive a common set of input data. The weighting of the input data may vary based upon the strategy. It is also possible to run different input in different strategies.

### Strategy-Based Module

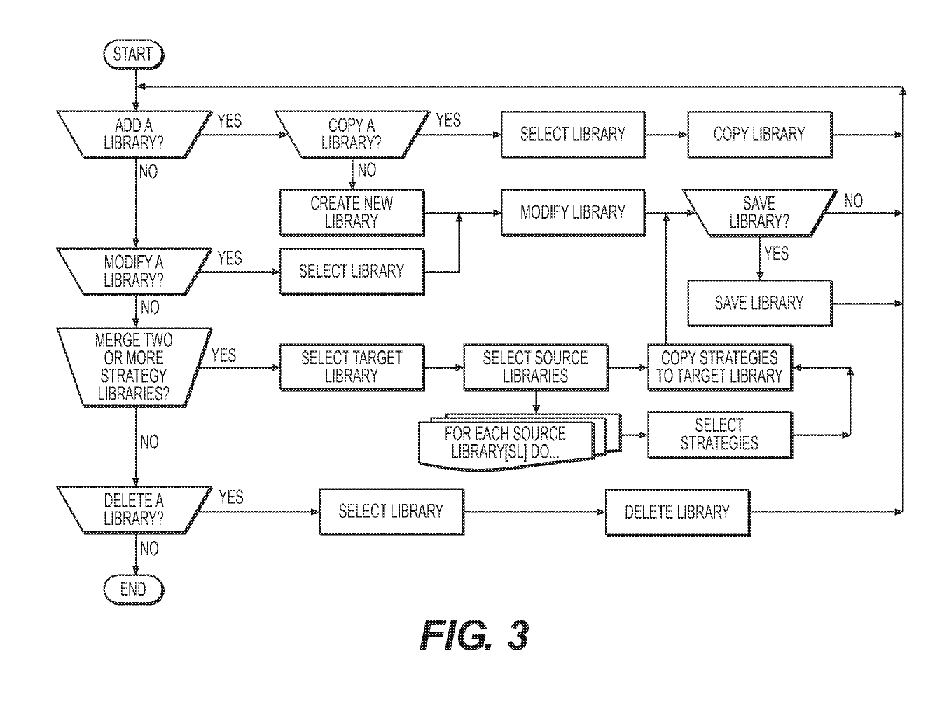

The strategy-based module contains one or more strategies making decisions that relate to the operation of the facility. Each strategy is a decision making method, which may include business logic for determining the operation of the facility (e.g. setting decision variables) for a given set of parameter inputs. Different strategies are developed to address different business objectives or needs based upon various known objectives or drivers and unknown inputs (such as, for example, the cost of shipping or cost of fuel, etc). Because the decision-making process is made explicit in the strategy-based approach, the intent and motivation behind the result is more easily understood. Specifically, the result that is well suited to meet a known set of business drivers, or a result that preferred on the basis of a selected metric. As such, the decision maker will have a better understanding of the results even though it might seem counter to the results generated from an optimizer. Each strategy may be constructed of any suitable components and may further involve the use of mathematical model(s), simulation calculations, rules or logic, optimization, or other analytic tools. Furthermore, the results may highlight the impact of a particular uncertain parameter (e.g., a particular shipment arriving late). Knowing the parameter, the user can take action to influence the outcome of an uncertain parameter to the extent that they can (e.g., taking corrective steps to make certain a particular shipment does not arrive late or as close to the preferred time as possible). Or, the use can take action to minimize any negative impact (or maximize any positive impact) associated with the uncertainty parameter. The strategy-based module may use multiple different strategies since there can be more than one decision-making process. Different strategies may perform better under different conditions. The strategy-based module may also contain interface tools that allow the user to create strategies, as well as add, save, delete, modify, edit, select, copy, merge, or organize into libraries or groups, or any other administrative task. FIGS. 2 and 3 show examples of actions that can be applied for working with strategies and strategy libraries. The presently disclosed subject matter permits the user to run input cases through different strategies to determine what strategies are more resilient to an uncertain parameter. If no strategy is sufficiently resilient, then a strategy may be modified or combined with another to improve the resiliency with respect to the uncertain parameter.

FIG. 7 illustrates the process for using the strategy-based module in accordance with the presently disclosed subject matter. As mentioned above, the user identifies the parameters or drivers that are necessary to be considered. The user can select a desired strategy or the module can identify the relevant strategy or strategies based upon the desired parameters or drivers identified by the user. FIG. 2 illustrates how the strategy or strategies can be selected, modified and/or combined. Strategies that are modified may be saved as new strategies. Similarly, strategies that can be combined may be saved as a new strategy. It is contemplated that the strategy library does not contain a static number of strategies; rather, the strategies can be modified and combined to create various new strategies to address specific business objectives or concerns. An existing strategy could be updated to reflect geographic specific factors or facility specific concerns.

Once the desired strategy or strategies have been selected, the necessary inputs can be added. The strategy based module will then identify results based upon the input and the specific selected strategies.

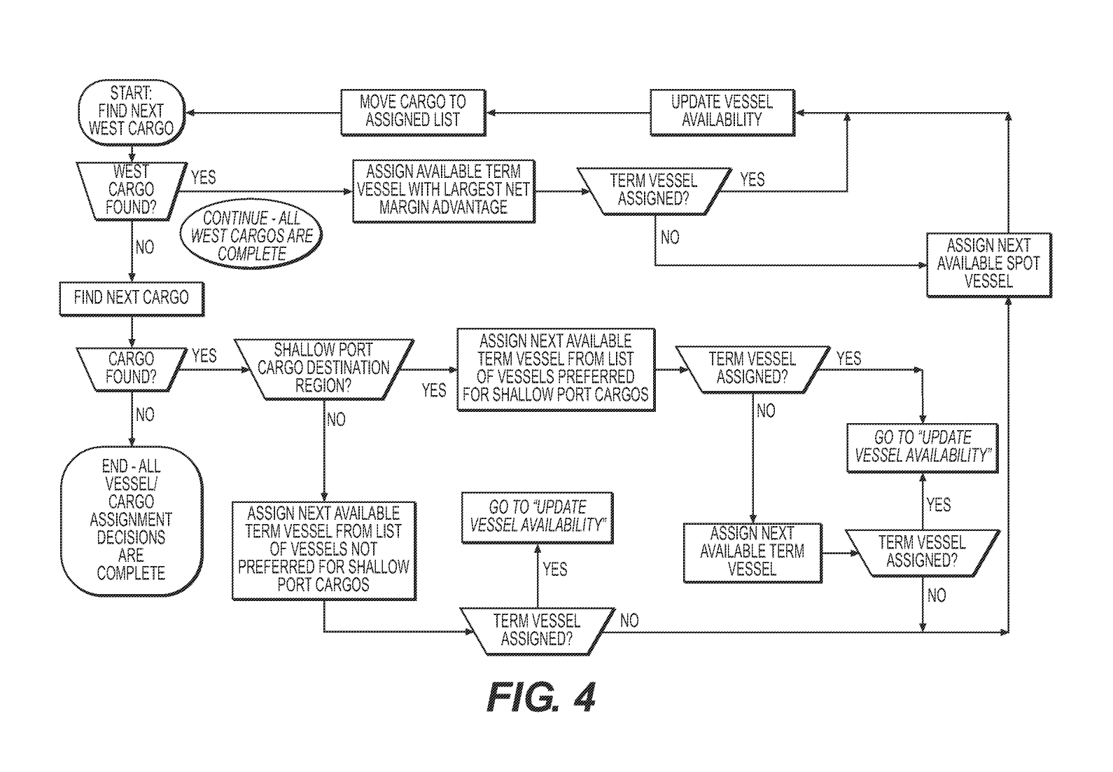

As an example in the context of petrochemical transportation, a strategy may be used for making decisions in the cargo assignment and/or scheduling of transport vessels. Such a strategy could be a basis for making the vessel assignment decisions so as to determine the overall vessel program or schedule. To make a feasible vessel program, a vessel is assigned to each cargo. The profitability metric is total net margin. FIG. 4 shows an example of such an assignment strategy for formulating a vessel program for term and spot vessels for the delivery of cargo to two regions, West cargos (which are defined as those which discharge in the US or in NorthWest Europe) and East cargos (which are defined as those which discharge in the Asia Pacific region). One possible strategy that will be referred to, for purposes of illustration, as Strategy-1 will be described in greater detail.

### EXAMPLE

### Strategy-1

The underlying rationale for Strategy-1 is for the vessel program which maximizes the utilization and profitability of term vessels.

1. Calculate the profitability of each term vessels to perform a West cargo and compare to profitability to perform an East cargo. If West cargos are more profitable (e.g. net profit margin for West cargo exceeds new margin for East cargos by a specified amount), prefer the use of term vessels on West cargos. Otherwise, prefer the use of spot vessels for West cargos.

2. Certain term vessels are well suited to discharge cargo in shallow ports. Favor these vessels for cargos which discharge at shallow ports and assign these vessels accordingly.

3. After consideration of steps 1 and 2 above, assign the first available term vessel to the earliest cargo.

4. Assign a spot vessel to cover a cargo which does not have a term vessel assigned.

5. Continue until a vessel is assigned to each cargo. Consider cargos in chronological sequence based on the laycan (i.e., a specified time period) for the first load port.

### EXAMPLE

### Strategy-2

The underlying rationale for Strategy-2 is to consider cargos in chronological sequence based on the laycan for the first load port.

1. Assign the first available term vessel to the current cargo.

2. Assign a spot vessel to cover a cargo which does not have a term vessel assigned.

3. Continue until a vessel is assigned to each cargo.

### EXAMPLE

### Strategy-3

The underlying rationale for Strategy-3 is to consider the largest net margin for each cargo.

1. Find the available term vessel with the largest net margin for the current cargo. Assign this term vessel to this cargo.

2. Assign a spot vessel to cover a cargo which does not have a term vessel assigned.

3. Continue until a vessel is assigned to each cargo.

The strategy based module can then generate a vessel program (e.g. a set of vessel-cargo assignments) based upon each of the three selected strategies. The user will then see the results in light of the underlying strategy. The module can run multiple cases for each of the strategies to generate multiple programs that are consistent with a particular strategy. The user can then compare the results generated with each strategy against one or more performance metric(s) and select the preferred strategy. The tool may report the strategy element that produced each decision. Such transparency in the decision-making process can lead to improved understanding of individual decisions and of the entire vessel program.

The presently disclosed subject matter is not limited to the transport of cargo; rather, the strategy based module may employ strategies that address various aspects of scheduling and operating the facility. In connection with the scheduling the operations associated with the front-end of a refinery, the operations to be scheduled include: vessel discharges (i.e., the amounts transferred from the vessel (cargo) to facility (e.g., refinery) storage tanks); tank transfers (i.e., the amounts transferred from the storage tanks to the charge tanks); and crude distiller blends (i.e., the amounts transferred from refinery charge tanks to the crude distillers). Each of these operations may be made on the basis of a strategy.

### EXAMPLE

### Vessel Volume Discharge Strategy

The Vessel Volume Discharge Strategy could be outlined as:

1. Select a vessel based on First In First Out, i.e., among the vessels waiting to be discharged of their cargos, select the vessel that arrived first.

2. Discharge the crudes on board the vessel to the refinery storage tanks based on an optimization model, with the following considerations:
(i) Each vessel crude cargo must be completely discharged, but can be split into multiple storage tanks;
(ii) The total amount of crude transferred to a storage tank is less than or equal to the available ullage of the storage tank (defined as: tank capacity—current content)
(iii) Maximize an objective function based on a weighted sum of value functions.

An example of a suitable objective function is

$$Objective = {\sum }_{c = 1}^{N\_C} {\sum }_{tks = 1}^{N\_TKS} f ( {x}_{c , tks} , {U}_{tks} )$$

where c is an index of the set of cargos, tks is an index of the set of storage tanks, x is a variable denoting the amount assigned of cargo c to tank tks and U_(tks) denotes the ullage of the storage tank. The function f(x,U) can be linear, piece-wise linear or non-linear based on the decision-makers' preferences. Since the value function f is based solely on volumetric information (x and U), we will denote this decision-making approach or strategy as a “Vessel Volume Discharge Strategy”.

### EXAMPLE

### Tank Transfer Volume Strategy

The Tank Transfer Volume Strategy could be outlined as:

1. Identify the storage tanks and charge tanks that are available for operations (i.e., they are not in the midst of an ongoing operation).

2. Transfer the contents from the storage tanks to the charge tanks based on an optimization model, with the following considerations:
(i) The amount transferred from each storage tank is less than or equal to the difference of the content of the storage tank and the tank heel
(ii) The total amount of crude transferred to a charge tank is less than or equal to the available ullage of the charge tank (defined as: tank capacity—current content)
(iii) Maximize an objective function based on a weighted sum of value functions.

An example of a suitable objective function is

$$Objective = {\sum }_{tks = 1}^{N\_TKS} {\sum }_{tkc = 1}^{N\_TKC} f ( {z}_{tks , tkc} , {U}_{tkc} )$$

where tks is an index of the set of storage tanks, tkc is an index of the set of charge tanks, z is a variable denoting the amount assigned from tank tks to tank tkc, and U_(tkc) denotes the ullage of the charge tank. The volume-centric basis for the tank-transfer strategy can be denoted as “Tank Volume Strategy”.

### EXAMPLE

### Max Crude Distiller Rate Strategy

The Crude Distiller Strategy could be outlined as:

1. Identify the charge tanks that are available for operations (i.e., they are not in the midst of an ongoing operation).

2. Set the feed ratios from the charge tanks to the crude distillers based on running the latter at maximum capacity and ensuring that the run-length satisfies a minimum duration.

In accordance with the presently disclosed subject matter, it is contemplated that multiple strategies may be combined or linked to obtain the desired operating strategy. For example, the three “front-end” strategies previously discussed could be combined together into an overall planning strategy for scheduling the operations of the front-end of the refinery over a time horizon 1 . . . T is as outlined below:

Step 0: Set t=1

Step 1: At time t:
a) Are the crude distillers running?
   i) If No, schedule them according to “Max Crude Distiller Rate” strategy. Update status of crude distillers and tanks
   ii) If Yes, go to Step b.
b) Are there vessels waiting to be discharged?
   i) If No, go to Step c.
   ii) If Yes, discharge them according to “Vessel Volume Strategy”. Update status of vessels and tanks.
c) Are there storage tanks available for transfer?
   i) If No, go to Step 2.
   ii) If Yes, discharge them according to “Tank Volume Strategy”. Update status of tanks

Step 2: If t=T, stop, else set t=t+1 and go to Step 1.

The above described combined strategy can be adapted at many different levels to yield other strategies with different emphases. New strategies can be obtained by changing (i) the order of operations (b) and (c), i.e., discharging the vessels after enough room has been created in the storage tanks; (ii) the basis of Vessel selection from FIFO to one based on demurrage incurred at the end of the discharge operation; or (iii) the value function f(x, U) to g(q, U) where q denotes the qualities of the crude cargo and tank contents, which would change the “Volume Strategy” to a “Quality Strategy”. An additional variation would be h(x,q,U), which would be a way of balancing volumetric and quality considerations.

### Input Cases

Input data describing the scenarios under which the problem is to be solved is provided as input cases. The type of parameters being used and their associated data will vary depending on the operational problem being solved. For example, for a vessel assignment problem, input data may include the following types of information: freight rates, bunker fuel costs, demurrage rates, vessel speed, load region ETA (estimated time of arrival) for term vessels, etc. Multiple (two or more) cases are generated with each case containing input values for the parameters used in the strategy-based module. These cases can be generated in any suitable manner, including by user input or calculation by the computer system.

Typically, at least one of the parameters used by the strategy-based module is an uncertain parameter having multiple possible values. Parameters having relatively more certainty may be given a single expected value as input. Parameters with a significant amount of associated uncertainty (e.g. the cost of bunker fuel for ships at a future date) may be given a range of possible values to account for the uncertainty. For example, for the parameter on the cost of bunker fuel, three input values (e.g., a low estimate, a mid-range estimate and a high estimate of cost) may be used in developing the program based upon the strategy. For example, these input values for bunker fuel may be set as follows: low estimate price=560 ($/ton), midrange estimate price=600, and high estimate price=660.

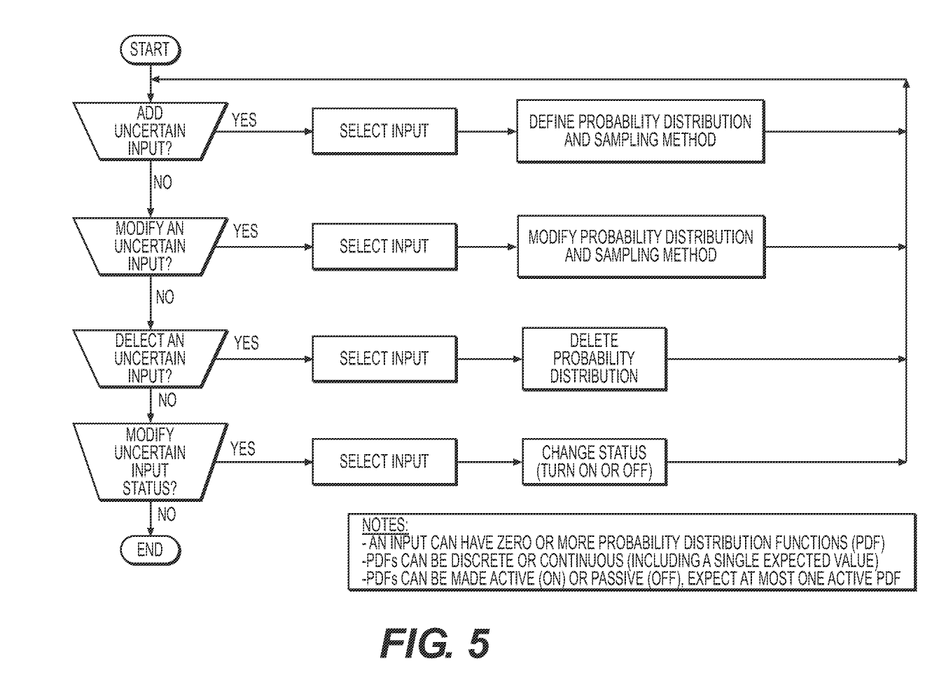

These input values may be received in any suitable manner, including manual entry, loading from a spreadsheet or database, or the input values may be selected or calculated by the tool (e.g. samples selected from a distribution of input values). FIG. 5 shows an example of actions that can be applied for entering inputs for uncertain parameters. Because one or more of the parameters are considered uncertain, the decision making tool permits a range of possible input values to be considered in the analysis. Thus, each input case is also associated with the probability of that particular combination of parameter values occurring. The weighting of each case can be calculated in any suitable manner. It is contemplated that the weighting may be based upon a probability or some other factor. For example, each possible input value may be given a weighting factor based on its normalized relative weighting within the sample of input values being used and these weighting factors for different parameters may be multiplied to obtain the weighting of each case.

The weighting factors may be received in any suitable manner, including input by the user, loading of weighting data, or calculation by the tool itself. In some cases, for each parameter, the tool may receive multiple possible input values and the probability of that input value occurring. For example, for a parameter X whose value is subject to substantial uncertainty, the user may input values x1, x2, and x3 as possible parameter values, along with a weighting factor (for each of x1, x2, and x3) based on the normalized relative weighting of that particular value in relation to the other possible values. A second uncertain parameter Y may have values y1, y2, and y3 as possible values along with corresponding weighting factors. Weighting factors for pairs of values for parameters X and Y (eg. x1 and y1, x1 and y2, etc) can be determined by combining the weighting factors for each individual parameter. These weighting factors represent the weightings for various parameter value pairs.

In some cases, historical data for one or more of the uncertain parameters may be received. This data may be modeled (e.g. as a probability distribution) using regression, curve fitting, or other suitable technique. The tool can select multiple values using the model and assign a weighting factor for each based on the probability of that value occurring. For example, the tool may fit a curve or a model to the historical data and select certain values from the fitted curve.

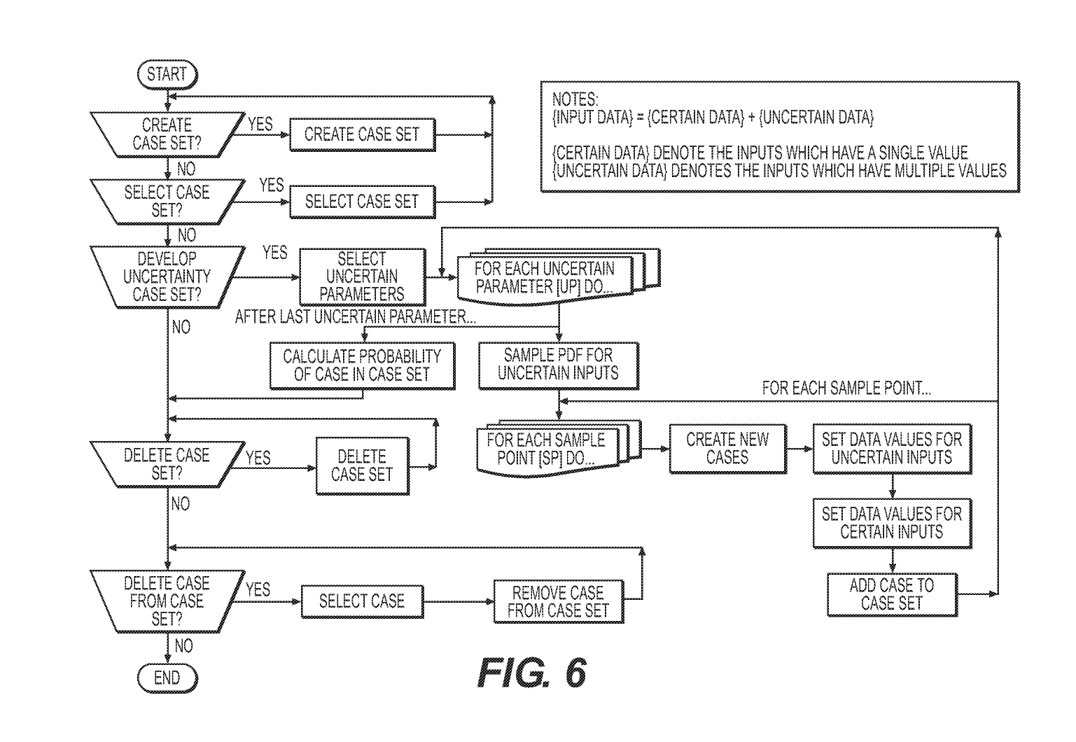

Thus, a set of input cases is generated, with each input case containing a different set of values for the parameters, and each input case being associated with a weighting for that set of values for the parameters. FIG. 6 shows an example of actions that can be applied for working with case sets.

### Results

Having generated a set of input cases, these cases are processed in the strategy-based module. In particular, the set of input cases are processed using the strategy-based module to obtain calculations for the performance of each different strategy. That is, the parameter values in each case are used as input for each strategy and the resulting performance metric for that case is calculated. In the vessel program example given above, an input case is applied to the strategy to develop a vessel program. The total net margin for this vessel program is calculated and used as the metric to evaluate the vessel program. Other metrics can be used to evaluate the performance of a vessel program, such as the utilization rate for term vessels, the overall bunker fuel cost, etc. Additional strategies (similar or different from the example given above) can be used to develop vessel programs. FIG. 7 shows an example of actions that can be used to evaluate strategies using case sets.

### Performance Metrics

For comparison, the results of the different strategies can be measured against a common performance metric. Examples of performance metrics that can be used include: profitability (e.g. total net margin), cost (e.g. overall bunker fuel cost), utilization rate for term vessels, plant equipment utilization, production quantity, production time, etc.

Because each input case being processed has an associated probability of that particular case scenario occurring, the performance results are also associated with the same probability. Thus, the performance results for each different strategy has a probability distribution. This probability distribution can be analyzed and represented in any suitable manner, including calculating variances (from the mean), standard deviations, area under the curve, etc. The probability distribution may be continuous or discrete, non-cumulative or cumulative. This information can be provided in any suitable form, including the use of tables, graphs, or charts.

In one example, because each strategy approach is considered over a range of “n” different case scenarios, a probability curve (e.g. cumulative probability curve) for each approach can be generated over those “n” case points. The probability distribution curve gives the range of expected outcomes and the likelihood of obtaining each outcome. Therefore, the probability distribution curve represents the robustness of each strategy approach and provides a way to evaluate the different strategies based on their robustness.

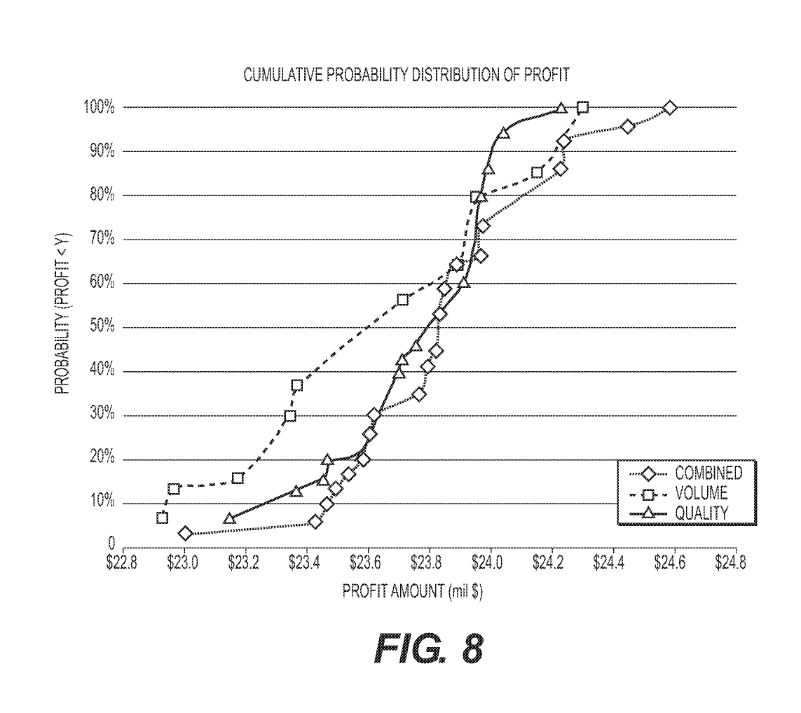

For example, FIG. 8 shows cumulative probability distribution curves from a set of input cases applied to three different strategies. The strategies are designated as being a volume strategy (▪), a quality strategy (▴), and a combined strategy (♦). The x-axis plots the amount of profit obtained using the selected strategy. The y-axis plots the cumulative probability of that amount of profit (i.e. probability that the profit amount is no larger than the plotted amount). Each curve represents the outcome of a particular strategy and collectively, the curves indicate the relative robustness of the strategies.

These curves demonstrate that the combined strategy (♦) produces the greatest potential profit, but its profitability performance is not as robust as the quality strategy (▴). One indicator of robustness is the width of the curve, which represents the range of possible profit values as a risk profile. In other words, in relation to risk profile, a strategy that produces a narrower probability distribution provides a more robust solution. The volume strategy (▪) is inferior in terms of both profitability and robustness. Thus, our decision support tool allows different strategies to be compared against each other so that the organization can make better-informed judgments about which strategy to deploy.

### Performance Targets

In some cases, these results from the strategy-based module may be further compared to a performance target for the performance metric. This performance target can be generated from any source or technique that demonstrates other results that might be possible if a different approach was used. For example, the performance target may be calculated by applying optimization techniques, from historical data (e.g. a previously obtained empirical result), or by the use of simulations.

In some cases, the computer system may also be programmed to use a simulation-based module for determining a performance target. The simulation-based module contains at least one model that simulates the operation of the facility. The model may be a mathematical model containing a set of equations or formulas relating to the operation of the facility and is configured to be analyzed for a specific performance metric of the facility. The model may be a programming model upon which optimization techniques can be applied, such as a linear programming (LP) model, a nonlinear programming (NLP) model, mixed-integer linear programming (MILP) model, or mixed integer nonlinear programming (MINLP) model. Such programming models may include an objective function, equality and inequality constraints, and problem data such as prices, supply and demand figures, equipment capacity limits, etc. The model may be used in any suitable way to analyze the performance of the manufacturing facility. In some cases, optimization techniques may be applied to the model to obtain decision variable results that optimize the desired performance metric. For example, the user may apply a solver to the model using a case (or multiple cases) to obtain an optimal solution to a specific case (or multiple cases). Or, the user can apply a solver using a case (or multiple cases) to obtain one or several feasible solutions to a specific case (or multiple cases). The solution may comprise numerical values of model variables, a value of the objective function, and other information such as marginal values for constraints and variable bounds.

Examples of simulation-based decision support tools that can be used in the presently disclosed subject matter include those disclosed in commonly assigned US Patent Application Publication No. 2009/0187450 entitled “System for optimizing transportation scheduling”, commonly assigned US Patent Application Publication No. US 2010/0287073 entitled “Method for optimizing a transportation scheme”, commonly assigned US Patent Application Publication No. 2008/0294484 entitled “System for optimizing transportation scheduling and inventory management of bulk product from supply locations to demand locations”, commonly assigned US Patent Application Publication No. 2010/0332273 entitled “Tools for assisting in petroleum product transportation logistics”, and commonly assigned US Patent Application Publication No. 2009/0192864 entitled “System for optimizing bulk product allocation, transportation and blending.” The disclosures of each are incorporated herein in their entireties.

The simulation-based module may further use logic and/or rules in the simulation analysis. The simulation-based module may also employ a scheduler tool, which uses the rules, logic, priorities, or user input to determine values for the decision variables. One possible way to use the simulation-based module involves using the scheduler to provide values for decision variables and using the simulation to calculate the result of those decision variables. The process is: (a) decision variables or degrees of freedom are set by scheduler; (b) calculate the result of these decision variables and execute the simulation; (c) assesses the simulation results; (d) return to step (a) and adjust until acceptable results are obtained. It is also contemplated that the decision variables or degrees of freedom may be set by rules/logic built into the simulation-based module, or by solving the model as an optimization problem.

An example of a simulation-based tool is a ship assignment optimization model that solves a vessel scheduling problem using linear programming (LP) and mixed-integer linear program (MILP) technology. The business decisions are assignment of term and spot vessels to a known set of cargos. The scheduling aspect of this problem pertains to the cargo laycans (a given time-window, for example, a pair of start and end dates) for the cargo loading and discharge activities, and to the projected vessel availability (e.g. estimated time of arrivals for vessels).

This particular tool uses a simulation to calculate schedules for vessel activities, and optimization calculations to maximize load quantities and to maximize the profitability of the overall vessel program. This decision support tool determines an optimal vessel program and determines an assignment of a vessel to each of the cargos so as to maximize overall profitability. The metric for profitability is the overall (or total) net margin. The net margin calculation includes the market value for a vessel to perform a cargo transport minus the cost for a vessel to perform the cargo transport plus a revenue contribution based on the time when a term vessel is projected to complete the cargo transport.

The set of input cases are also processed using the simulation-based module and the resulting performance metric for each case is calculated (e.g. solve the model as an optimization problem for the given set of parameter values). The results from the simulation-based module can serve as a performance target for assessing the performance of a strategy(s). For example, the strategy(s) can be compared against the optimized performance metric calculated by the simulation-based module.

### Modifying Strategies

After assessing the performance of a strategy (e.g. against other strategies or against the optimized result), the user can elect to modify a strategy (this action is intended to include the creation of a new strategy) with improved performance. This modification of a strategy can be performed in various ways. In some cases, the decision outcomes produced by a strategy is compared to the decision outcomes produced by other strategy(s) or those produced by the simulation-based module. By analyzing the differences in the decision outcomes, the strategy can be modified (e.g. by revising a strategy, creating a new strategy, or combining elements of different strategies).

In some cases, a strategy can be modified based on a sensitivity analysis that determines the relative importance of the uncertain parameters for a given performance metric. This sensitivity analysis can be performed by observing how much the performance metric output changes relative to the amount of change in the value for the uncertain parameter(s). For example, a sensitivity analysis can be performed by using a common set of weighted ranges for each of the uncertain parameters. By comparing how much variation there is in the outcomes over the weighted ranges, the relative importance of uncertain parameters can be determined. Tornado charts are an effective means to display this information and enable a user to identify the critical uncertain parameters. By focusing on specific (for example, the parameters that were identified as being more important during the sensitivity analysis) uncertain parameters, a strategy can be modified to give improved performance. In particular, the modification may involve the changing or adding of steps that involve (directly or indirectly) the selected uncertain parameters. This modification of the strategy can be performed iteratively to improve the performance of the strategy and improve the resiliency of the strategy with respect to the uncertain parameters. The strategy may also be modified to incorporate or reflect business drivers that may not have been previously considered. The modified and/or new strategies may then be saved in the relevant library for future use.

In some cases, this sensitivity analysis can be performed for multiple different strategies and the differences in the sensitivities can be compared to determine how to modify a strategy. In some cases, a sensitivity analysis for the uncertain parameters using the simulation-based module can be performed in a similar manner. In some cases, a sensitivity analysis for determining the relative importance of decision variables for a given performance metric can be performed in a similar manner.

### ILLUSTRATIVE EXAMPLE

An application of the presently disclosed subject matter to vessel scheduling will be described in greater detail below with reference to Strategy-1, Strategy-2 and Strategy-3, discussed above.

The three different decision making strategies (Strategy-1, Strategy-2, and Strategy-3 have been described above) are defined and stored, for example, using the methodology identified in FIG. 3. The input data comprises: a set of cargos, a set of available term and spot vessels, freight cost information, etc. The uncertain input parameter is the cost of bunker fuel (eg. in $/ton) where 3 values are defined with corresponding weighting factors:

TABLE 1
Uncertain Input Parameter and Weighting Factors

| Price [$/ton] | Weighting factor |
|---|---|
| 560 | 0.2 |
| 600 | 0.5 |
| 660 | 0.3 |

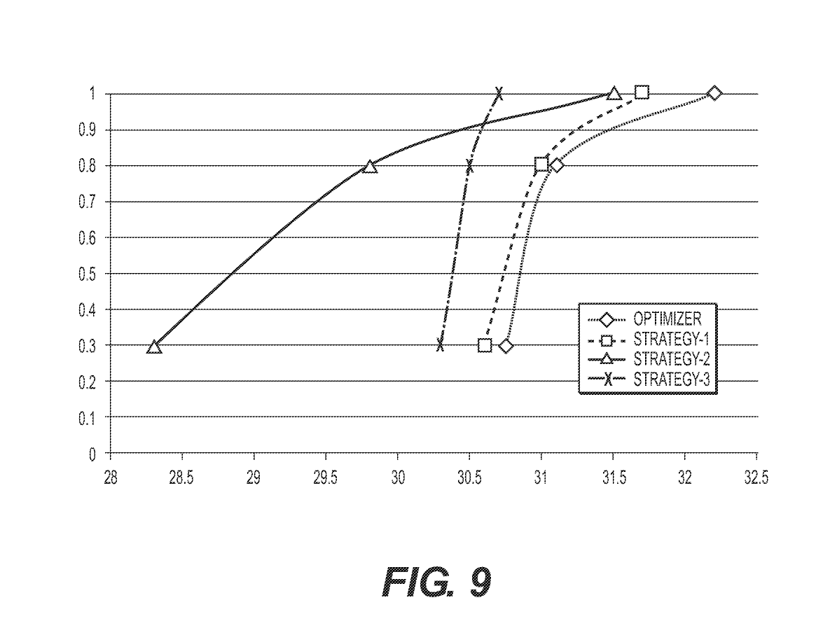

Based on the uncertain input parameter (as shown above) and the other input parameters, three cases are generated (Case1, Case2, and Case3). Each case defines the relevant problem data. Evaluate the three cases using each of the three strategies. Each case may also be evaluated using an optimizer. The total net margin for each case, is calculated using each strategy and using the optimizer. Total net margin is the chosen performance metric in this instance. The net margin results (values in the table are in units of millions of $) are tabulated below in Table 2 and the probability distribution profile for each strategy is shown in FIG. 9.

TABLE 2
Net Margin Results for Each Strategy

| | | | | | Cumulative |
|---|---|---|---|---|---|
| | Strategy-1 | Strategy-2 | Strategy-3 | Optimizer | Probability |
| Case 1 | 31.7 | 31.5 | 30.7 | 32.2 | 100 |
| Case 2 | 31 | 29.8 | 30.5 | 31.1 | 80 |
| Case 3 | 30.6 | 28.3 | 30.3 | 30.75 | 30 |

FIG. 9 is one example of a risk profile for the total net margin performance metric. The y-axis represents the cumulative probability and the x-axis represents the total net margin. At a given cumulative probability (eg. 0.8 or 80%), the total net margins for the three strategies and the optimizer can be compared. For instance, the Optimizer has the largest total net margin (31.1) and Strategy-1 has the second largest total net margin (31.0). Strategy-3 has the smallest range of total net margin values (30.3-30.7) which can be interpreted to mean that this strategy is the most robust for the given case set. Strategy-2 has the largest range of total net margin values (28.3-31.5). Strategy-1 is the best performing strategy for the given case set.

(e) Based on the performance of the three strategies for the selected performance metric (total net margin), the decision maker may select Strategy-1 as the preferred strategy.

(f) The decision maker therefore may elect to schedule and operate the vessels according to Strategy-1. The Optimizer results can be used as a target estimate for the total net margin performance metric and the performance of Strategy-1 (and other strategies) can be assessed versus this target. This may indicate an opportunity to improve upon the results from best known strategy.

One means to improve upon Strategy-1 is consider the differences between the results from Strategy-1 and the Optimizer. The largest difference in the total net margin occurs in Case 1 (32.2 vs 31.7). By comparing the difference in the decisions (in addition to the performance metric), Strategy-1 can be improved. Consider Strategy-4 below which also considers the vessel capacity (eg. cubic capacity of the vessel in kB) and the maximum cargo quantity (eg. based on the upper tolerance for the cargo) and favors the use of vessels with large capacity for cargos with larger maximum quantity. Strategy-4 is a modification of the Strategy-1, discussed above.

### EXAMPLE

### Strategy-4

1. Calculate the profitability of each term vessels to perform a West cargo and compare to profitability to perform an East cargo. If West cargos are more profitable (e.g.

net profit margin for West cargo exceeds new margin for East cargos by a specified amount), prefer the use of term vessels on West cargos. Otherwise, prefer the use of spot vessels for West cargos.

2. Consider term vessel cubic capacity and the maximum cargo quantity for cargos which have no vessel assigned. Favor the assignment of vessels with large cubic capacity to large cargos.

3. Certain term vessels are well suited to discharge cargo in shallow ports. Favor these vessels for cargos which discharge at shallow ports and assign these vessels accordingly.

4. After consideration of steps 1, 2, and 3 above, assign the first available term vessel to the earliest cargo.

5. Assign a spot vessel to cover a cargo which does not have a term vessel assigned.

6. Continue until a vessel is assigned to each cargo. Consider cargos in chronological sequence based on the laycan for the first load port.

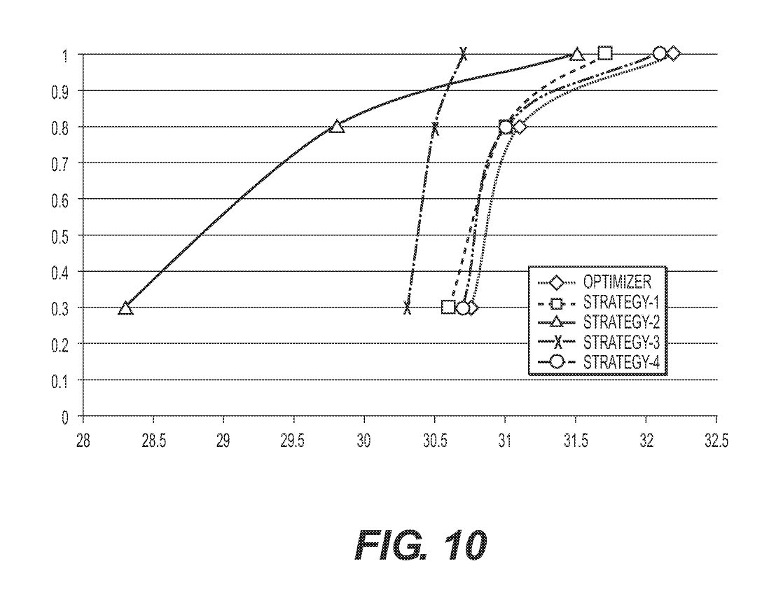

The three input cases, described above, are evaluated utilizing Strategy-4. The net margin results (values in the table are in units of millions of $) which now include Strategy-4 are tabulated below in Table 3 and the probability distribution profile for each strategy, which now include Strategy-4 is shown in FIG. 10.

TABLE 3
Net Margin Results for Each Strategy

| | Strat- | Strat- | Strat- | Strat- | | Cumulative |
|---|---|---|---|---|---|---|
| | egy-1 | egy-2 | egy-3 | egy-4 | Optimizer | Probability |
| Case 1 | 31.7 | 31.5 | 30.7 | 32.1 | 32.2 | 100 |
| Case 2 | 31 | 29.8 | 30.5 | 31 | 31.1 | 80 |
| Case 3 | 30.6 | 28.3 | 30.3 | 30.7 | 30.75 | 30 |

As can be seen from FIG. 10, the performance of Strategy-4 is improved over Strategy-1. The performance of Strategy-4 is better than the performance of Strategies 1, 2 and 3. The difference between the performance of Strategy-4 and the target performance has been reduced.

### Miscellaneous

The presently disclosed subject matter may also be embodied as a computer-readable storage medium having executable instructions for performing the various processes as described herein. The storage medium may be any type of computer-readable medium (i.e., one capable of being read by a computer), including non-transitory storage mediums such as magnetic or optical tape or disks (e.g., hard disk or CD-ROM), solid state volatile or non-volatile memory, including random access memory (RAM), read-only memory (ROM), electronically programmable memory (EPROM or EEPROM), or flash memory. The term “non-transitory computer-readable storage medium” encompasses all computer-readable storage media, with the sole exception being a transitory, propagating signal. The coding for implementing the present invention may be written in any suitable programming language or modeling system software, such as AIMMS. Solvers that can be used to solve the equations used in the present invention include CPLEX, XPress, KNITRO, CONOPT, GUROI, and XA.

The presently disclosed subject matter may also be embodied as a computer system that is programmed to perform the various processes described herein. The computer system may include various components for performing these processes, including processors, memory, input devices, and/or displays. The computer system may be any suitable computing device, including general purpose computers, embedded computer systems, network devices, or mobile devices, such as handheld computers, laptop computers, notebook computers, tablet computers, mobile phones, and the like. The computer system may be a standalone computer or may operate in a networked environment.

Although the various systems, modules, functions, or components of the present invention may be described separately, in implementation, they do not necessarily exist as separate elements. The various functions and capabilities disclosed herein may be performed by separate units or be combined into a single unit. Further, the division of work between the functional units can vary. Furthermore, the functional distinctions that are described herein may be integrated in various ways.

The foregoing description and examples have been set forth merely to illustrate the invention and are not intended to be limiting. Each of the disclosed aspects and embodiments of the present invention may be considered individually or in combination with other aspects, embodiments, and variations of the invention. Modifications of the disclosed embodiments incorporating the spirit and substance of the invention may occur to persons skilled in the art and such modifications are within the scope of the present invention.

We claim:

1. A method of operating a facility, comprising:
(a) using a computer system that stores a strategy-based module comprising multiple different strategies, each comprising a procedure for determining the operation of the facility; wherein the strategies use multiple input parameters, wherein at least one of the input parameters is an uncertain parameter having multiple possible values;
(b) generating a set of input cases, each input case containing a different set of values for the parameters, and each input case being associated with a weighting for that set of values for the parameters;
(c) evaluating the set of input cases using each strategy in the strategy-based module and calculating a performance metric for each strategy for each input case;
(d) analyzing the weighted distribution of the performance metric over the set of input cases for each strategy;
(e) selecting or modifying a strategy based on the analysis of the weighted distributions; and
(f) operating the facility according to the results of the selected or modified strategy.

2. The method of claim 1, wherein the step of generating the set of input cases comprises receiving multiple input values for each uncertain parameter and a weighting factor for each input value relating to the probability of that input value occurring.

3. The method of claim 2, wherein the weighting of each input case is calculated using the weighting factors of the input values of the uncertain parameters.

4. The method of claim 3, wherein the weighting factor for each input value is a normalized relative weighting of that input value within the sample of input values being used, and wherein the weighting factors of the input values in each input case are multiplied together to calculate the weighting of that input case.

5. The method of claim 1, wherein the step of generating the set of input cases comprises:
receiving historical data for one or more of the uncertain parameters;
fitting a model to the historical data;
selecting multiple values from the fitted model; and
assigning a weighting factor for each of the selected values based on the probability of that input value occurring.

6. The method of claim 1, wherein the performance metric is net profit margin.

7. The method of claim 1, wherein operating the manufacturing facility comprises one or more of:
physically transferring a material to or from a vessel;
physically transferring a material to or from a storage tank;
physically transferring a material to or from a processing equipment; or
transforming a feed or raw material into a different material.

8. The method of claim 1, wherein analyzing the weighted distribution comprises displaying one or more weighted distribution curves on a graph.

9. The method of claim 8, wherein the weighted distribution curves are superimposed on one another.

10. The method of claim 1, wherein analyzing the weighted distribution comprises determining the cumulative weighted distributions of each strategy.

11. The method of claim 1, wherein the uncertain parameter has two or more different values in the set of input cases, and wherein at least one other parameter is constant over the set of input cases.

12. The method of claim 1, further comprising:
performing a sensitivity analysis of a strategy to select an uncertain parameter that has relatively more impact on the performance metric than another uncertain parameter; and
modifying or adding a step in the strategy that involves the selected uncertain parameter.

13. The method of claim 12, further comprising displaying the results of the sensitivity analysis on a tornado chart.

14. The method of claim 1, wherein the computer system further stores a simulation-based module comprising a model of the operation of the facility according to the performance metric; and wherein the model uses the multiple input parameters used by the strategy-based module, the method further comprising:
evaluating the set of input cases using the model and optimizing the model to obtain an optimized performance metric for each input case;
analyzing the weighted distribution of the optimized performance metric over the set of input cases; and
comparing the weighed distribution analysis of the strategies and the optimized performance metric.

15. The method of claim 1, wherein the manufacturing facility is a petrochemical facility.

16. The method of claim 1, wherein the selected strategy produces a narrower weighted distribution than another one of the strategies.

17. The method of claim 1, wherein the selected strategy produces a narrower weighted distribution and a better performance metric result than another one of the strategies.

18. The method of claim 1, further comprising:
performing a sensitivity analysis of a strategy to identify key input parameters; and
mitigating the impact of uncertain parameter that are identified as key input parameters.

19. A computer system for determining the operation of a facility, the computer system being programmed to perform steps that comprise:
(a) storing a strategy-based module comprising multiple different strategies, each comprising a procedure for determining the operation of the facility; wherein the strategies use multiple input parameters, wherein at least one of the input parameters is an uncertain parameter having multiple possible values;
(b) generating a set of input cases, each input case containing a different set of values for the parameters, and each input case being associated with a probability for that set of values for the parameters;
(c) evaluating the set of input cases using each strategy in the strategy-based module and calculating a performance metric for each strategy for each input case; and
(d) analyzing the probability distribution of the performance metric over the set of input cases for each strategy.

20. A non-transitory machine-readable storage medium comprising instructions which, when executed by a processor, cause the processor to:
(a) store a strategy-based module comprising multiple different strategies, each comprising a procedure for determining the operation of the facility; wherein the strategies use multiple input parameters, wherein at least one of the input parameters is an uncertain parameter having multiple possible values;
(b) generate a set of input cases, each input case containing a different set of values for the parameters, and each input case being associated with a probability for that set of values for the parameters;
(c) apply the set of input cases to each strategy in the strategy-based module and calculating a performance metric for each strategy for each input case; and
(d) analyze the probability distribution of the performance metric over the set of input cases for each strategy.

21. A method of operating a facility, comprising:
(a) using a computer system that stores a strategy-based module comprising multiple different strategies, each comprising a procedure for determining the operation of the facility; wherein the strategies use multiple input parameters;
(b) generating an input case that defines a set of values for the input parameters;
(c) evaluating the input case using each strategy in the strategy-based module and calculating a performance metric for each strategy;
(d) comparing the performance metric results for the different strategies;
(e) selecting or modifying a strategy based on the comparison; and
(f) operating the facility according to the results of the selected or modified strategy.

22. A method of operating a facility, comprising:
(a) using a computer system that stores a strategy-based module comprising multiple different strategies, each comprising a procedure for determining the operation of the facility; wherein the strategies use multiple input parameters, wherein at least one of the input parameters is an uncertain parameter having multiple possible values;
(b) generating a set of input cases, each input case containing a different set of values for the parameters, and each input case being associated with a weighting for that set of values for the parameters;
(c) evaluating the set of input cases using each strategy in the strategy-based module and calculating a performance metric for each strategy for each input case; and
(d) operating the facility according to the results.
